(19) United States
(12) Patent Application Publication
(10) Pub. No.: US 2010/0284178 A1
(43) Pub. Date: Nov. 11, 2010

(54) Magnetic tire light system

(76) Inventors: Cezar J. Rodriguez, San Bernardino, CA (US); Gail R. Rodriguez, San Bernardino, CA (US)

Correspondence Address: EMERY L. TRACY, P.O. BOX 1518, BOULDER, CO, 80306, US

(21) Appl. No.: 12/799,888

(22) Filed: May 4, 2010

Related U.S. Application Data
(60) Provisional application No. 61/215,536, filed on May 5, 2009.

(51) Int. Cl. F21L 13/06; F21L 4/00

(52) U.S. Cl. 362/192; 362/157

(57) ABSTRACT

A lighting system for providing motorists the necessary light for nighttime and low light conditions and vehicle breakdowns is provided. The lighting system comprises an outer housing having a base surface. A light source extends from the outer housing with the light source selectively providing light. A power source powers the light source and an activation mechanism activates the light source. A magnet is secured to the base surface of the outer housing, with the magnet being positioned substantially opposite the light source wherein the outer housing is releasably securable to a metal surface at any angle allowing the light source to be directed in any desired direction.

The present application claims the benefit of priority of pending provisional patent application Ser. No. 61/215,536, filed on May 5, 2009, entitled “Magnetic Tire Light”.

### BACKGROUND OF THE INVENTION

1. Field of the Invention

This invention relates generally to a magnetic tire light system and, more particularly, the invention relates to a magnetic tire light system providing motorists the necessary light for nighttime and low light breakdowns.

2. Description of the Prior Art

It has become a commonplace to observe that these days, practically no one can work on his or her own car. Even routine maintenance like changing the oil and filter, cleaning or replacing spark plugs and wires, performing a tune-up, are better left these days to the expert mechanic. As cars have become, to large degree, less mechanical and more electronic, the amateur shade-tree backyard mechanic has largely disappeared, replaced by the auto technician wearing a lab-coat and operating a sophisticated array of electronic diagnostic computer equipment. Time was, a man could purchase the Chilton manual on his vehicle, figure out what was wrong with it, buy the parts he needed at a parts store or junkyard, then repair the car on his own. Nowadays, most attempts in that direction do more harm than good, and we wind up going to the mechanic not only to fix what was wrong, but also to fix the things we broke in trying to fix it. Perhaps the single remaining aspect of auto repair that all of us, sooner or later, must encounter and master is changing a flat tire at the side of the road. Oddly enough, while a flat tire or blow-out is certainly a matter of inconvenience, the simple, self-reliant act of changing a blown tire can leave us with a heightened sense of accomplishment and self-confidence, the proven assurance that we can, in some respects at least, still take care of ourselves amid adversity. This is well and good, but the fact is, relatively few motorists are fully prepared to meet a roadside emergency.

### SUMMARY

The present invention is a lighting system for providing motorists the necessary light for nighttime and low light conditions and vehicle breakdowns. The lighting system comprises an outer housing having a base surface. A light source extends from the outer housing with the light source selectively providing light. A power source powers the light source and an activation mechanism activates the light source. A magnet is secured to the base surface of the outer housing, with the magnet being positioned substantially opposite the light source wherein the outer housing is releasably securable to a metal surface at any angle allowing the light source to be directed in any desired direction.

In addition, the present invention includes a method for providing motorists the necessary light for nighttime and low light conditions and vehicle breakdowns. The method system comprises providing an outer housing having a base surface, extending a light source from the housing, powering the light source, selectively activating the light source, securing a magnet to the base surface of the outer housing substantially opposite the light source, and releasably securing the outer housing to a metal surface at any angle.

The present invention further includes a lighting system for providing motorists the necessary light for nighttime and low light conditions and vehicle breakdowns. The lighting system comprises an outer housing having a base surface and a light source extending from the outer housing. A flexible neck extends from the outer housing with the light source mounted to the flexible neck. A folding rotary crank powers the light source and an activation switch selectively activates the light source. A magnet is secured to the base surface wherein the outer housing is releasably securable to a metal surface at any angle and wherein the flexible neck allows the light source to be directed in any desired direction.

### BRIEF DESCRIPTION OF THE DRAWINGS

FIG. 1 is a perspective view illustrating a flashlight of a magnetic tire light system, constructed in accordance with the present invention;

FIG. 2 is another perspective view illustrating the flashlight of the magnetic tire light system, constructed in accordance with the present invention;

FIG. 3 is a top plan view illustrating a mat of the magnetic tire light system, constructed in accordance with the present invention; and

FIG. 4 is a top plan view illustrating a folding box of the magnetic tire light system, constructed in accordance with the present invention.

### DETAILED DESCRIPTION OF THE PREFERRED EMBODIMENTS

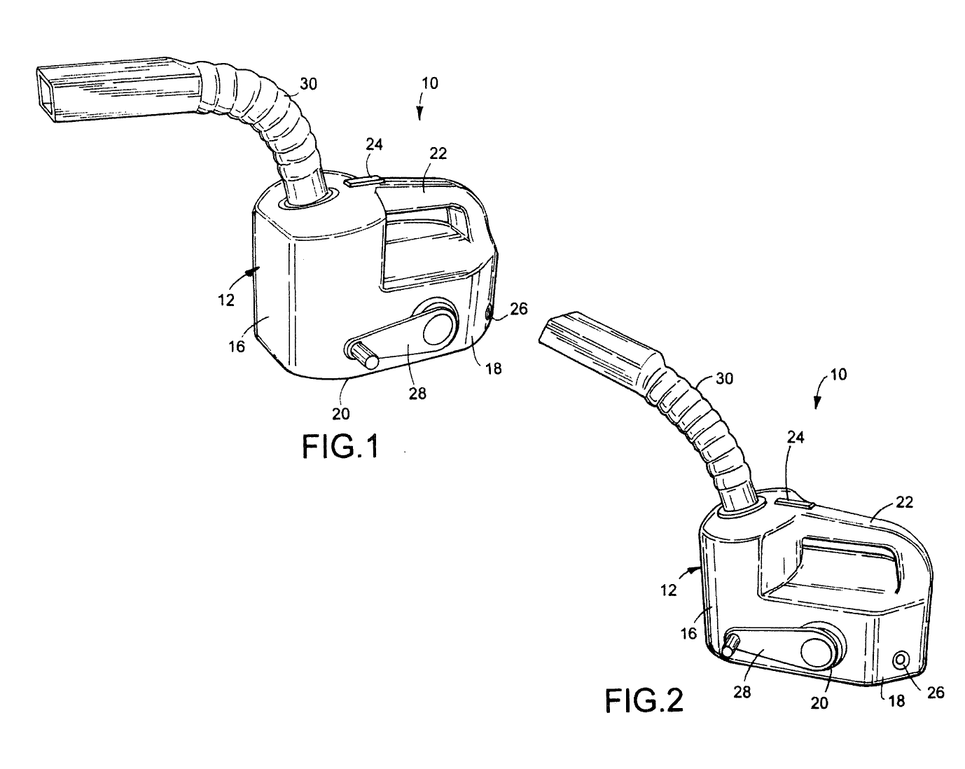

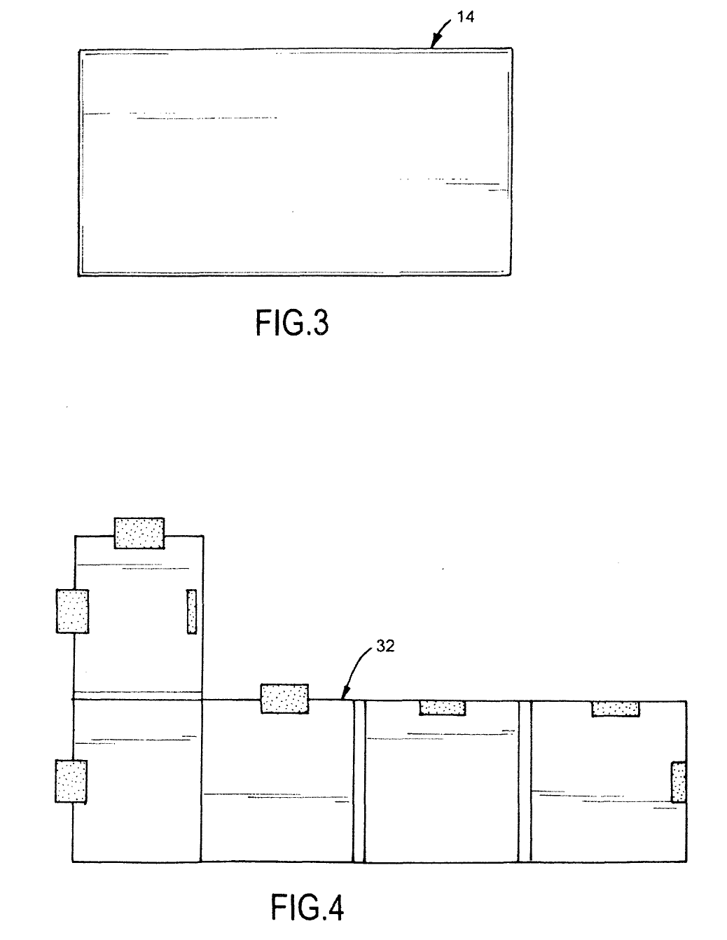

As illustrated in FIGS. 1-4, the present invention is a magnetic tire light system, indicated generally at 10, providing motorists the necessary light for nighttime and low light conditions and vehicle breakdowns. The magnetic tire light system 10 of the present invention combines a flashlight 12 together with a comfortable, cushioned mat or pad 14 (see FIG. 3) thereby providing motorists with two components of a fully reliable emergency kit for roadside breakdowns in low light conditions. Simply stated, the magnetic tire light system 10 equips motorists with a flexible, easily charged emergency magnetic flashlight or lamp 12 and a folding rubberized pad 14 on which to kneel when performing tire-changes or other repairs.

As stated above, the magnetic tire light system 10 of the present invention has a rechargeable emergency flashlight or lamp 12. The flashlight 12 preferably has a rectangular housing 16, measuring approximately six and one-half (6½″) inches in length, approximately three and one-half (3½″) inches in height, and approximately three and one-half (3½″) inches in width although constructing the flashlight 12 with different dimensions is within the scope of the present invention. The flashlight housing 16 is preferably constructed of a tough, temperature- and impact-resistant, waterproof ABS plastic, with a substantially flat, planar base surface 18. The flat planar base surface 18 allows the motorist to place the flashlight 12 on a horizontal surface without the flashlight 12 tipping over.

The flashlight 12 of the magnetic tire light system 10 of the present invention has a magnet 20 secured thereto allowing the motorist to releasably mount the flashlight 12 to a metal surface. The magnet 20 can be permanently attached to the base surface 18 of the flashlight 12 with a permanent adhesive substance or the like or the magnet 20 can be releasably attached to the base surface 18 of the flashlight 12 with hook and loop fasteners, snaps, releasable adhesive, and the like. Further, it is within the scope of the present invention for the magnet 20 to completely cover the base surface 18 of the flashlight 12 or the magnet 20 can cover only a portion of the base surface 18 of the flashlight 12. Regardless, preferably, the magnet 20 secured to the base surface 18 is powerful enough to affix the flashlight 12 to any metal surface of the motor vehicle or other place.

Molded into the top of the housing 16 of the flashlight 12 of the magnetic tire light system 10 of the present invention is a handle 22. Preferably, the handle 22 is approximately four and three-quarters (4¾″) inches in length although constructing the handle 22 in different lengths is within the scope of the present invention. At the posterior base of the handle 22 is an On/Off switch 24. At the base below the posterior end of the handle 22 is a plug receptor 26 for the accessory power cord with the cord preferably being approximately eighteen (18″) feet in length and including an adapter for use with either a standard 110-volt electrical outlet or with a vehicle's cigarette lighter. Internal rechargeable batteries power the flashlight 12.

In a preferred embodiment of the magnetic tire light system 10 of the present invention is a folding rotary crank 28. When extended and cranked for approximately ninety (90) seconds (more or less), the rotary crank 28 operates a quality internal generator to charge the rechargeable lamp batteries for twenty-five (25) minutes of illumination. Ten (10) to fifteen (15) LEDs (light emitting diodes) provide the lamp illumination. The light emitting diodes are preferably encased in a pod or module at the end of a flexible neck 30 extending approximately twelve (12″) inches from the top of the lamp housing 16 at the anterior end of the handle 22 with the flexible neck 30 permitting the flashlight 12 to be directed in any direction. The flexible neck 30 allows the flashlight 12 to be directed in any desired direction once the flashlight 12 is mounted in its desired position.

As briefly mentions above, in addition to the flashlight 12, the magnetic tire light system 10 of the present invention includes a one-quarter (¼″) inch rubber pad 14, measuring approximately twelve (12″) inches by approximately sixteen (16″) inches. Furthermore, the magnetic tire light system 10 includes a carrying case and collapsible storage box 32 (see FIG. 4) with the storage 32 box composed of nylon panels joined for use with VELCRO fastening pads to hold lug nuts after being removed.

The magnetic tire light system 10 of the present invention presents a number of distinct and significant benefits and advantages. Foremost, the magnetic tire light system 10 presents motorists with two essential and highly advanced components of a roadside emergency kit. The magnetic tire light system 10, featuring a bright, flexible LED flashlight 12 with a quality hand-crank charger 28 and a magnetic base 20. In the event of a flat tire or other roadside emergency, the motorist retrieves the flashlight 12 of the magnetic tire light system 10 from the trunk of the vehicle. Then, using either the power cord or cigarette-lighter adapter, or by cranking the hand-crank 28 for ninety (90) seconds, the flashlight 12 is powered. The magnetic base 20 of the flashlight 12 permits the motorist to attach the flashlight 12 to the vehicle at the site required, i.e., to a fender or quarter-panel in the event of a tire-change, to the interior of the hood in the event of a mechanical problem. This is a great advantage, because up to now, the motorist equipped with an ordinary flashlight had to have a helper to hold the flashlight, or attempt to work with inadequate illumination. With the flashlight 12 of the magnetic tire light system 10, the motorist has full illumination of the working area, and has both hands free to perform the work.

The flashlight 12 of the magnetic tire light system 10 of the present invention is weatherproof, tough, and durable, and because the flashlight 12 can be charged instantly via the hand-crank 28, there are no batteries to buy or replace. Further, because tire-changes and other roadside repairs require the motorist to kneel by the vehicle, the magnetic tire light system 10 includes a cushioned, supportive rubber mat 14 to intercede between knee and ground. Given the prevalence of broken glass and other debris on highway shoulders and breakdown lanes, the cushioned mat 14 does more than provide comfort while kneeling since it also protects the motorist from potential injury. Compact, handy, and immediately ready for use at any time, the magnetic tire light system 10 comes in its own compact carrying case, suitable for inclusion in a vehicle's emergency kit and taking up very little room in the vehicle's trunk or storage compartment.

A crank-charged, flexible-neck flashlight 12 with a magnetic base 20, and an accompanying rubber mat 14, the flashlight 12 of the magnetic tire light system 10 can be quickly charged and attached to the vehicle to provide illumination for roadside repairs, while the mat 14 provides a clean, protective surface on which to work, for example, at changing a flat tire.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

What is claimed is:

1. A lighting system for providing motorists the necessary light for nighttime and low light conditions and vehicle breakdowns, the lighting system comprising:
an outer housing having a base surface;
a light source extending from the outer housing, the light source selectively providing light;
power means for powering the light source;
activation means for activating the light source; and
a magnet secured to the base surface of the outer housing, the magnet being positioned substantially opposite the light source;
wherein the outer housing is releasably securable to a metal surface at any angle allowing the light source to be directed in any desired direction.

2. The lighting system of claim 1 and further comprising:
a cushioned pad disconnected and separate from the outer housing.

3. The lighting system of claim 1 wherein the bottom surface is substantially flat and planar, the housing positionable on any horizontal surface without tipping over.

4. The lighting system of claim 1 wherein the magnet is permanently attached to the base surface of the outer housing.

5. The lighting system of claim 1 wherein the magnet is releasably attached to the base surface of the outer housing.

6. The lighting system of claim 1 wherein the magnet completely covers the base surface of the outer housing.

7. The lighting system of claim 1 wherein the magnet covers only a portion of the base surface of the outer housing.

8. The lighting system of claim 1 and further comprising:
a handle secured to the housing substantially opposite the base surface.

9. The lighting system of claim 1 wherein the power means is a folding rotary crank, the rotary crank, when rotated, provides power to the light source.

10. The lighting system of claim 1 wherein the light source is at least one light emitting diode mounted at the end of a flexible neck, the flexible neck allowing light to be directed in any desired direction.

11. The lighting system of claim 1 and further comprising:
a collapsible storage box.

12. A method for providing motorists the necessary light for nighttime and low light conditions and vehicle breakdowns, the method system comprising:
providing an outer housing having a base surface;
extending a light source from the housing;
powering the light source;
selectively activating the light source;
securing a magnet to the base surface of the outer housing substantially opposite the light source; and
releasably securing the outer housing to a metal surface at any angle.

13. The method of claim 12 and further comprising:
providing a cushioned pad disconnected and separate from the outer housing.

14. The method of claim 12 wherein the bottom surface is substantially flat and planar, and further comprising:
positioning the outer housing on any horizontal surface without tipping over.

15. The method of claim 12 and further comprising:
completely covering the base surface of the outer housing with the magnet.

16. The method of claim 12 and further comprising:
covering only a portion of the base surface of the outer housing with the magnet.

17. The method of claim 12 and further comprising:
powering the light source with the rotation of a rotary crank.

18. The method of claim 12 and further comprising:
mounting the light source at an end of a flexible neck; and
directing the light in any desired direction.

19. The method of claim 12 and further comprising:
providing a collapsible storage box.

20. A lighting system for providing motorists the necessary light for nighttime and low light conditions and vehicle breakdowns, the lighting system comprising:
an outer housing having a base surface;
a light source extending from the housing;
a flexible neck extending from the housing, the light source mounted to the flexible neck;
a folding rotary crank for powering the light source;
an activation switch for selectively activating the light source; and
a magnet secured to the base surface;
wherein the outer housing is releasably securable to a metal surface at any angle; and
wherein the flexible neck allows the light source to be directed in any desired direction.
